(19) United States
(12) Patent Application Publication
(10) Pub. No.: US 2018/0042386 A1
(43) Pub. Date: Feb. 15, 2018

(54) User-Identifying Adjustable Smart Footstool

(71) Applicants: David R. Hall, Provo, UT (US); Dan Allen, Springville, UT (US); Steven J.M. Butala, Provo, UT (US); Ben Swenson, Lehi, UT (US); Gayun Kim, Provo, UT (US); Joshua Larsen, Spanish Fork, UT (US); Joe Fox, Spanish Fork, UT (US); Jared Reynolds, Pleasant Grove, UT (US); Cameron Price, Provo, UT (US)

(72) Inventors: David R. Hall, Provo, UT (US); Dan Allen, Springville, UT (US); Steven J.M. Butala, Provo, UT (US); Ben Swenson, Lehi, UT (US); Gayun Kim, Provo, UT (US); Joshua Larsen, Spanish Fork, UT (US); Joe Fox, Spanish Fork, UT (US); Jared Reynolds, Pleasant Grove, UT (US); Cameron Price, Provo, UT (US)

(21) Appl. No.: 15/234,220

(22) Filed: Aug. 11, 2016

(51) Int. Cl. A47C 7/50; F21V 23/04; A47C 9/00; A61H 1/02; A47K 17/02; G01G 19/52

(52) U.S. Cl. CPC A47C 7/506; A47K 17/028; G01G 19/52; A47C 9/00; A61H 1/0266; F21V 23/0471; A61H 2201/02; A61H 2201/10; H04R 1/028

(57) ABSTRACT

A user-identifying adjustable footstool that is capable of identifying individual users and automatically adjusting based on user-identification. The footstool can save preferences for different users, such as specific heights or angles. These preferences are called when a user is successfully identified by the footstool. The user-identifying adjustable footstool is particularly useful in conjunction with a toilet, to allow users to achieve individualized squatting positions while using traditional western toilets.

### BACKGROUND

### Field of the Invention

The present invention relates to the function and utility of footstools.

### Background of the Invention

Footstools are a common household item that have remained relatively unimproved over time and relatively untouched by modern innovation. Current footstools lack user specific optimization and the convenience of automation. The innovation addresses the issue of user-identifying adjustable footstools. Previous art in the field of the present invention reflects interest in adjustable footstools and smart footstools. However, the field yet lacks a footstool that combines the processing power of modern computational tools, the precision of modern sensors, and the convenience of a smart footstool.

### SUMMARY

This invention has been developed in response to the present state of the art and, in particular, in response to the problems and needs in the art that have not yet been fully solved by currently available systems and methods. Accordingly, a user-identifying adjustable footstool has been developed. Features and advantages of different embodiments of the invention will become more fully apparent from the following description and appended claims, or may be learned by practice of the invention as set forth hereinafter.

To address the issue of user-identifying adjustable footstools, a footstool may provide a combination of sensors on a surface that may identify a specific user. Such sensors may include strain sensors, aromatic sensors, bio-impedance sensors, biometric sensors, or audio sensors. Data collected from these sensors will be useful to create one or more unique classifications for each user and allow for specific identification of repeat users.

Classification and identification of users may be accomplished through a processor that is housed in the body of the user-identifying adjustable footstool. The data that is collected and sorted may be stored in the on-board memory, facilitated by the creation of a profile for each user. A profile may store preferences for each user and allow automatic adjustment of the footstool upon successful identification of a user. Fingerprint sensors, voice recognition, weight sensors, force sensors, and bio-impedance electrode sensors may also contribute to identification and classification of each user.

A footstool may also save preferences for other functions of the footstool, such as temperature, massage, or lighting preferences, all of which may be controlled by a user accessible controller and subsequently tethered to a user profile for convenient adjustment at a subsequent use.

Consistent with the foregoing, a user-identifying adjustable footstool is disclosed. In one embodiment the user-identifying adjustable footstool is used as a toilet footstool, capable of nesting with a toilet. In another embodiment the user-identifying adjustable footstool comprises speakers and lights. In other embodiments the user-identifying adjustable footstool may be attached securely to a wall for increased stability, the top surface of the user-identifying may be used as a scale. Varying lifting mechanisms are set forth herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows a user-identifying adjustable footstool with sensors on a top surface;

FIG. 2 shows the user-identifying adjustable footstool with the top surface in the raised position;

FIG. 3 is a cross-sectional view of the user-identifying adjustable footstool;

FIG. 4 is a view of the user-identifying adjustable footstool nested with a toilet;

FIG. 5 is a view of the user-identifying adjustable footstool with the top surface in an angled position;

FIG. 6 is a side view of the user-identifying adjustable footstool in a raised and angled position, being used in conjunction with a toilet;

FIG. 7 is a top-down view of the user-identifying adjustable footstool in use with a toilet;

FIG. 8 is a side view of the user-identifying adjustable footstool mounted on wheels;

FIG. 9 is a view of the user-identifying adjustable footstool in use; and

FIG. 10 is a view of the user-identifying adjustable footstool with an attachment point proximate to a wall with a compatible attachment point.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

A detailed description of the claimed invention is provided below by example, with reference to embodiments in the appended figures. Those of skill in the art will recognize that the components of the invention as described by example in the figures below could be arranged and designed in a wide variety of different configurations. Thus, the detailed description of the embodiments in the figures is merely representative of embodiments of the invention, and is not intended to limit the scope of the invention as claimed.

In some instances, features represented by numerical values, such as dimensions, mass, quantities, and other properties that can be represented numerically, are stated as approximations. Unless otherwise stated, an approximate value means “correct to within 50% of the stated value.” Thus, a length of approximately 1 inch should be read “1 inch +/−0.5 inch.”

Aspects of the present invention are described herein with reference to flowchart illustrations and/or block diagrams of methods, apparatus (systems), and computer program products according to embodiments of the invention. Those of skill in the art will understand that each block of the flowchart illustrations and/or block diagrams, and combinations of blocks in the flowchart illustrations and/or block diagrams, may be implemented by computer readable program instructions. Additionally, those of skill in the art will recognize that the system blocks and method flowcharts, though depicted in a certain order, may be organized in a different order and/or configuration without departing from the substance of the claimed invention.

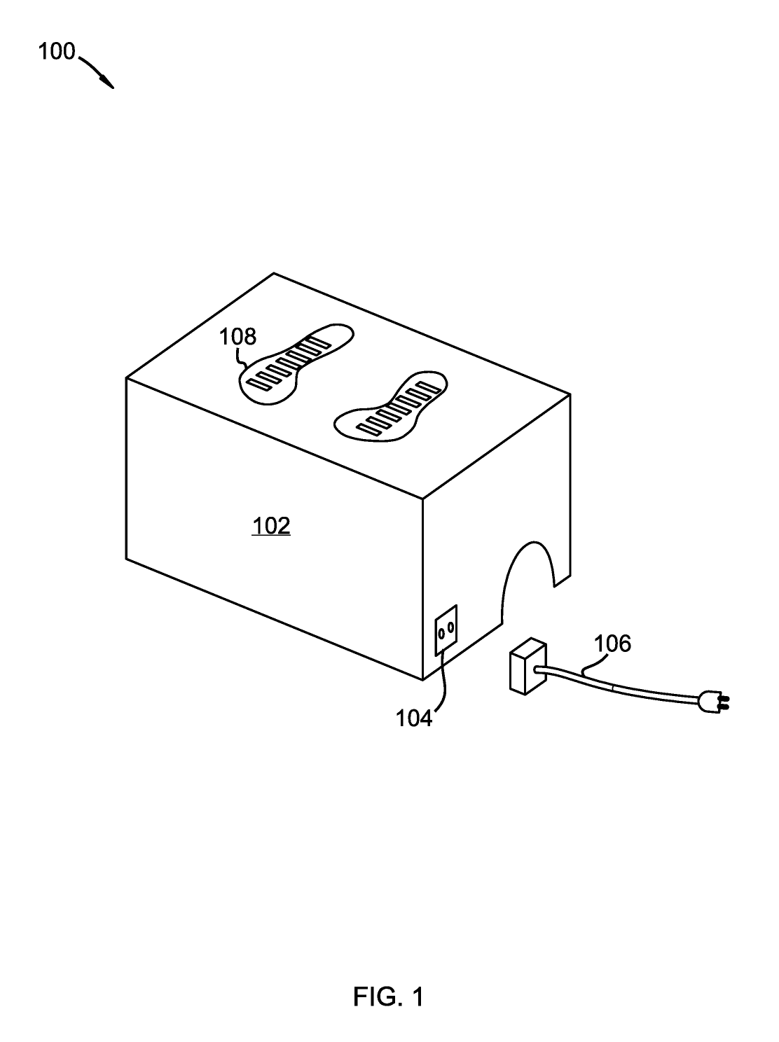

Referring to FIG. 1, user-identifying adjustable footstool 102 may be powered or charged by an electric cable 106 that may plug into a port 104 for powering internal electrical systems of the user-identifying adjustable footstool 102. Footpads 108 may comprise sensors and visible indicia indicating proper foot placement on a top surface of the footstool. Apparatus 100, may be used in combination with a toilet, couch, and/or may be used individually as a step stool.

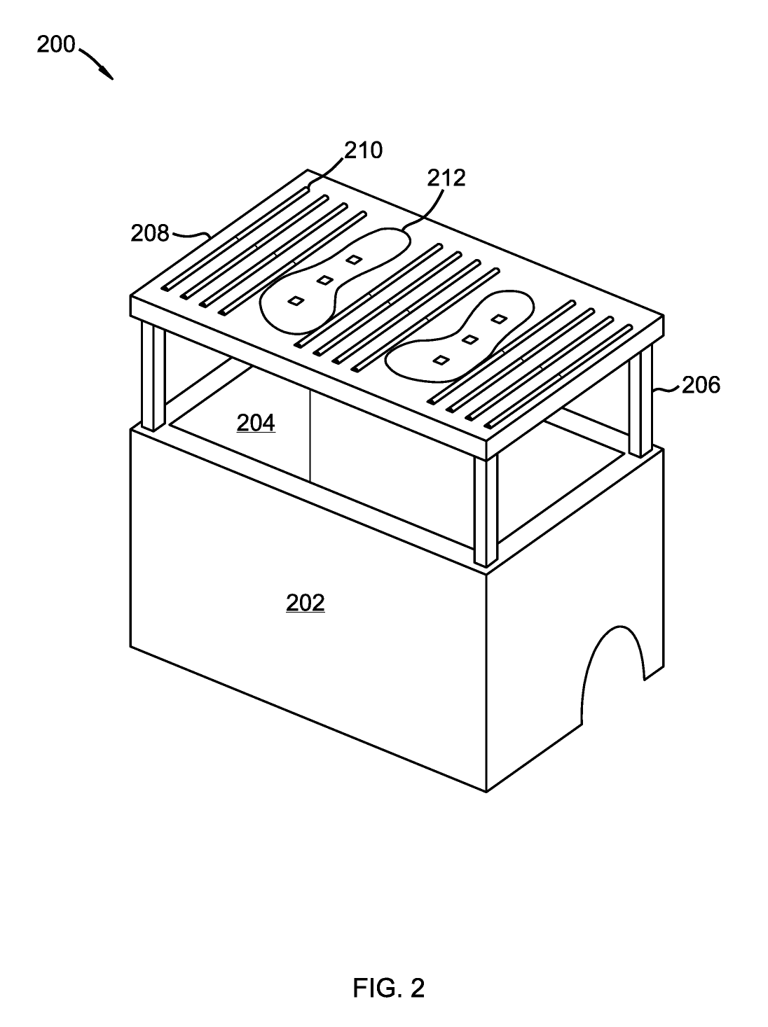

FIG. 2 shows a user-identifying adjustable footstool 202 in a raised position, supported by means of a lifting mechanism 206. Top surface 208 may have multiple height position settings. Height position settings may be user defined settings or may be learned positions based on sensor data and user identification data associated with footstool 202. Fingerprint sensors, voice recognition, weight sensors, force sensors, and bio-impedance electrode sensors may also contribute to identification and classification of each user. The lifting mechanism 206 may be comprised of rack and pinion mechanisms, screw drives, four-bar mechanisms, hydraulic lifts, motorized jack, or other mechanical systems known in the art of lifting mechanisms. The user-identifying adjustable footstool 202 may comprise an interior space 204 that may be used to house supplementary systems of the lifting mechanism 206, such as a battery, motor, controller, processor, memory, or other systems. A top surface 208 may be supported by the lifting mechanism 206 and may comprise texturing 210 that increases friction on the top surface 208 in order to help a user maintain increased stability while using the user-identifying adjustable footstool 202. The texturing 210 may comprise ridges, other raised figures, or any rough, high-friction surface. The top surface 208 may further comprise footpads and sensors 212 which may indicate to a user proper foot placement necessary for a user to be correctly identified.

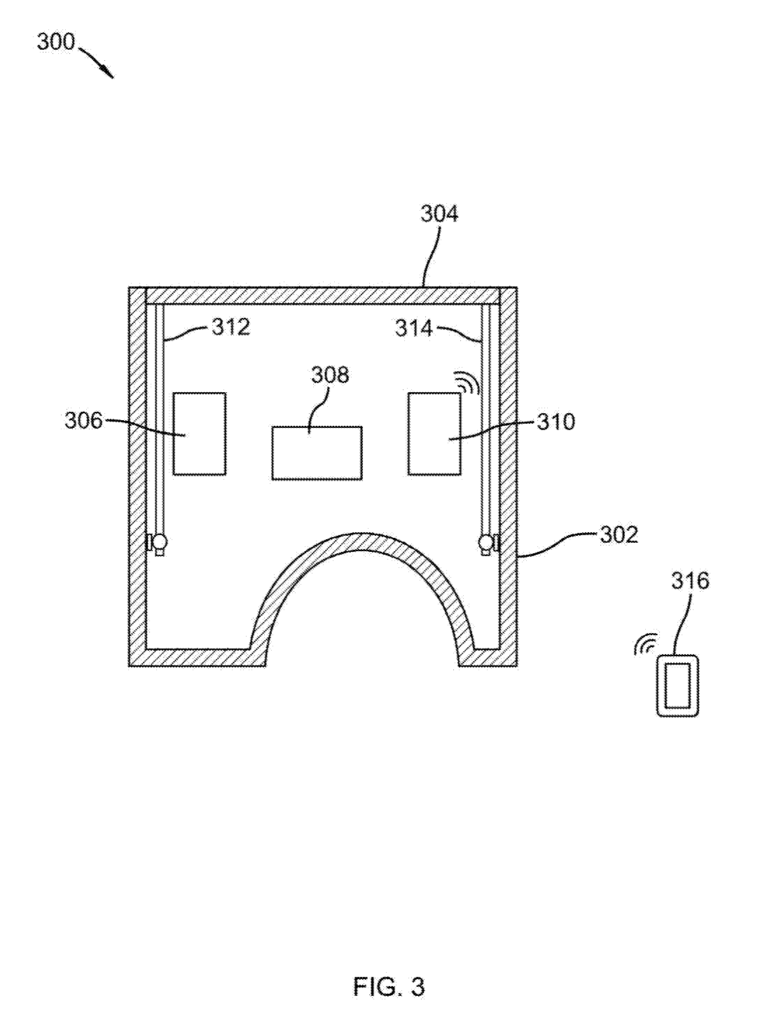

FIG. 3 shows a side cross-sectional view of a user-identifying adjustable footstool 302 with the top surface 304 in a lowered position. The top surface 304 may further comprise a thermal pad or a massage pad for increased user comfort. Also visible are lifting mechanisms 312 and 314, and contained within the user-identifying adjustable footstool 302 are stored components 306, 308, and 310. Stored components 306, 308, and 310 may be any combination of batteries, inverters, memory, or processors, motherboards, computers, controllers, motor drives, Ethernet controllers and wireless transceivers. Wired or wireless transceivers may be connected to wide and local area networks such as the Internet and other networks. Software may be stored in one or more memory locations associated with a stool controller. Memory locations may include within the footstool, within a user device, or in a remote location such as a database server or remote computer. The memory may contain user identification data obtained from fingerprint sensors, voice recognition, weight sensors, force sensors, and bio-impedance electrode sensors allowing identification and classification of each footstool user. A controller 316 may communicate wirelessly with stored component 314 to allow control of the functions of the user-identifying adjustable footstool 302. The controller 316 may be a user device such as a smartphone, iPad, laptop computer, remote control, etc. Functions of the user-identifying adjustable footstool 302 may include but are not limited to: adjustment of the height or angle of the the top surface, adjustment of the temperature of a thermal pad, or adjustment of the massage pattern of a massage pad. The memory may also save preferences of a user. Controller 316 may also be an application on a smartphone that allows for wireless control of the footstool.

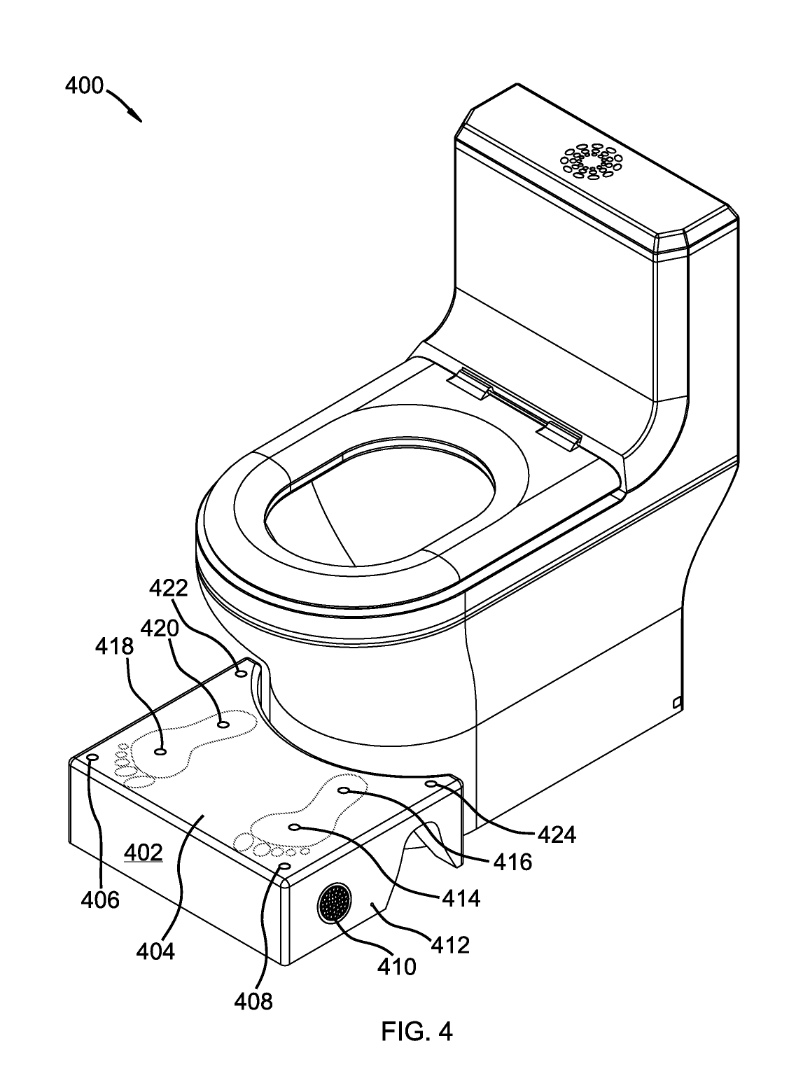

FIG. 4 shows a user-identifying adjustable footstool 402 nested with a toilet. A top surface 404 may comprise sensors 414, 416, 418, and 420, which are used to specifically identify a user. They may be any combination of strain sensors, aromatic sensors, bio-impedance sensors, biometric sensors, or audio sensors. The shape and number of the sensors 414, 416, 418, and 420 may vary with differing embodiments. A speaker 410 may be provided for the use of a user, and may be controlled wirelessly or by the use of an audio cable plugged into an audio port 412. Lights 406, 408, 422, and 424 may be attached to the user-identifying adjustable footstool 402 and may be manually activated or automatically activated by motion or pressure sensors. The lights 406, 408, 422, and 424 may come in a variety of forms and colors.

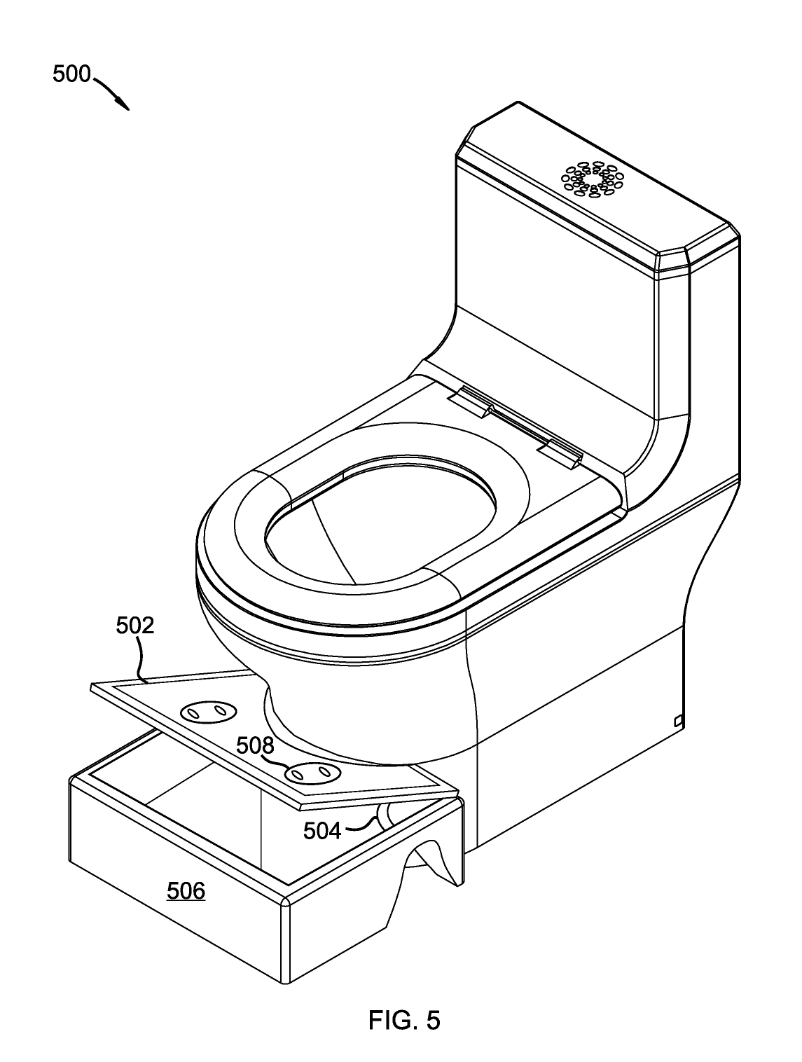

FIG. 5 shows a user-identifying adjustable footstool 506 nested with a toilet. A top surface 502 may rotate on a hinge to an angled position as shown in FIG. 5, a function that is useful for improved user comfort. The top surface 502 is supported by a mechanical or automated lifter 504. Lifter 504 may be connected to a controller and angled automatically to a user's preferred setting upon identification of a user. Software may be stored in one or more memory locations associated with a stool controller. Memory locations may include within the footstool, within a user device, or in a remote location such as a database server or remote computer. The memory may contain user identification data obtained from fingerprint sensors, voice recognition, weight sensors, force sensors, and bio-impedance electrode sensors allowing identification and classification of each footstool user. A user may also set an angle of the top surface by using a software application on a smartphone or other user device. Lifter 504 may also be mechanically adjusted by a user. Footpads and sensors 508 are present on the top surface 502. The footpads and sensors 508 may also comprise contouring for increased comfort of the user. The top surface 502 may also be partially coated with electrically conductive silicon to form electrodes for a user's feet.

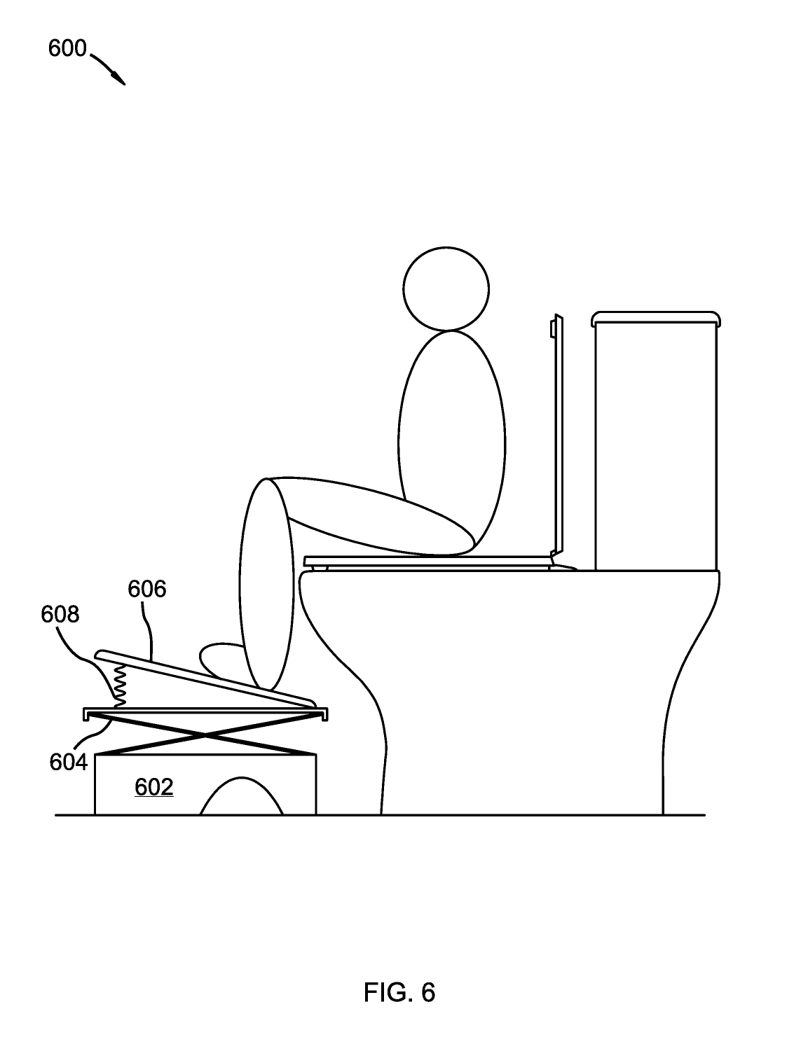

FIG. 6 shows a side view of a user-identifying adjustable footstool 602 being used in conjunction with a toilet. A top surface 606 is in an elevated and angled position, supported and adjusted by mechanical lifters 604 and 608. The angled nature and height of top surface 606 may be optimally adjusted to a toilet user's preference allowing for comfort and easier bowel movements. For example, a child may need assistance sitting on a toilet and the footstool 602 may recognize the child's voice and automatically lower and wait for the child to climb on top of the footstool and then lift the child to a position where the child can safely and accurately use the toilet.

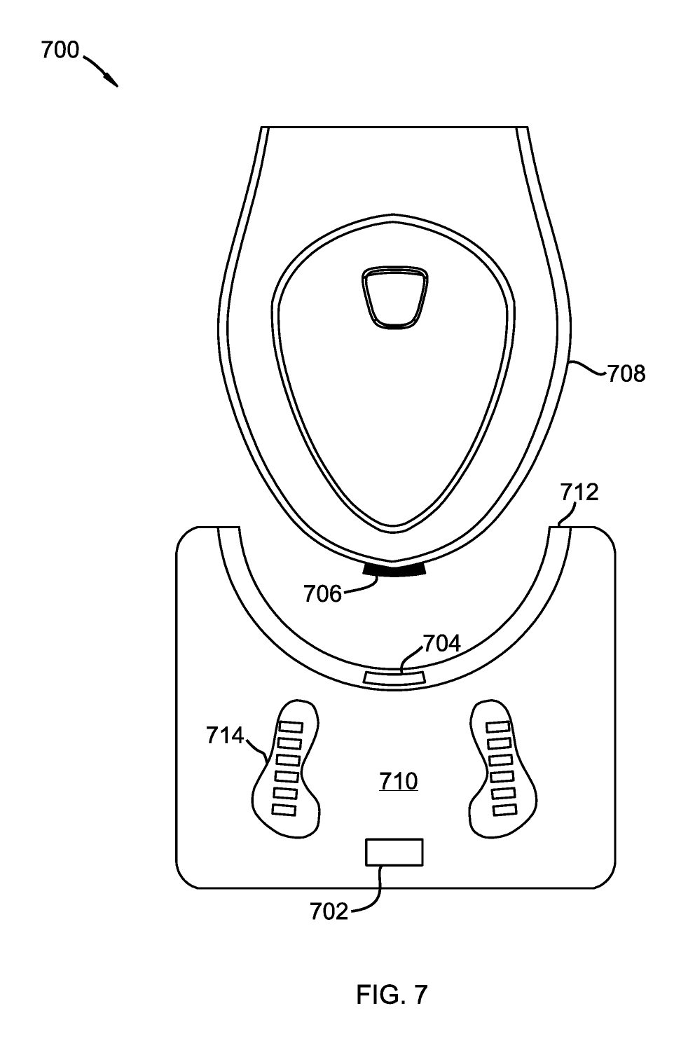

FIG. 7 shows a user-identifying adjustable footstool 710 from a top-down view. Foot pads and sensors 714 may be part of the top surface of the user-identifying footstool 710, the top surface of user-identifying footstool 710 may further comprise a screen or display for relaying data or other information to a user such as weight, body temperature, angle of the top surface, and height of the stool. Sensors 714 may be used to obtain weight, body temperature, and bio-impedance of a user. Concave side 712 comprises an attachment mechanism 704 that allows the user-identifying adjustable footstool to be attached or connected to a toilet 708 by means of an interface between attachment mechanisms 704 and 706. The attachment mechanisms 704 and 706 may be latching mechanism, magnets, electrical mechanical, optical (IR), clips, or some other means of attachment. They may also include conductive pins that could charge the user-identifying adjustable footstool 710 from a power source in the toilet 708.

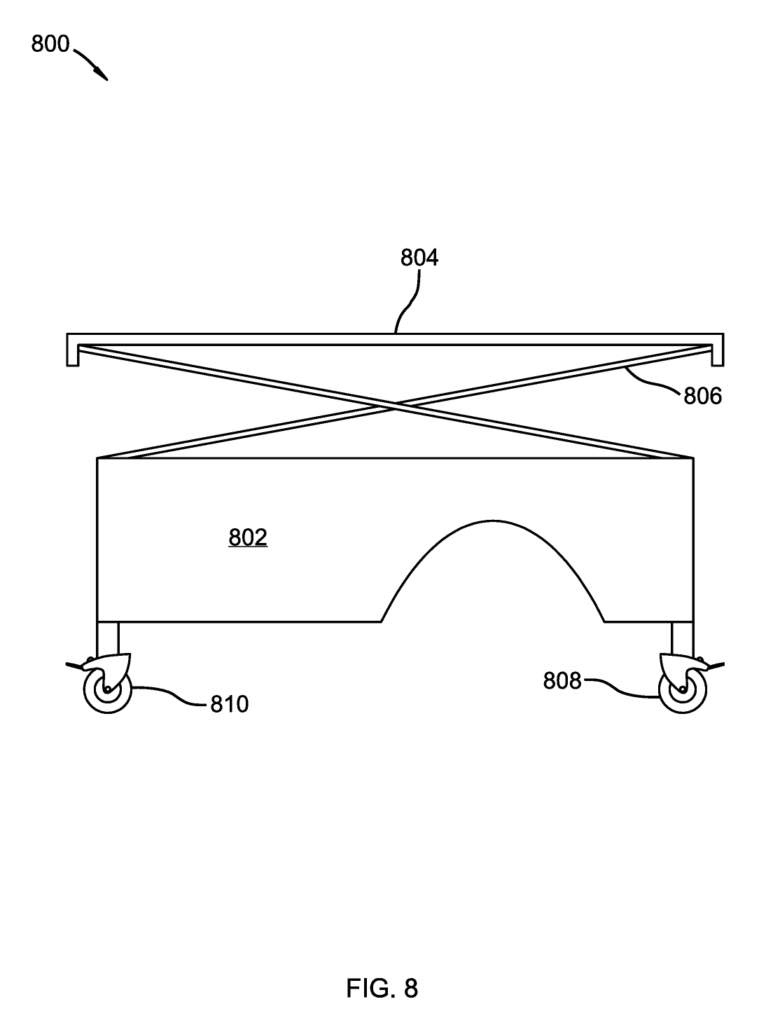

FIG. 8 shows a side view of a user-identifying adjustable footstool 802 with a top surface 804 in a raised position, supported by a motorized jack 806. The user-identifying adjustable footstool 802 may be supported by locking rollers 808 and 810. The locking rollers 808 and 810 may also comprise a suction device to increase stability. Rollers 808 and 810 may be powered rollers allowing the stool to reposition itself. Proximity sensors, GPS coordinates, gyroscopes, accelerometer, and optical transmitters and receivers may be used to determine position and location of a footstool and used to control direction and speed of movement of stool 802. For instance, a footstool controller, located within footstool 802, may contain cameras, GPS sensors, and acoustic sensors which may be used to automatically direct footstool 802 to a toilet or other power source for recharging when a battery supply within footstool 802 is low. Foot stool 802 may also contain a vacuum on a bottom side of the footstool which is used to clean floors and carpets in a home. The footstool may be able to located trash cans and dump a vacuum bag in a trash can autonomously.

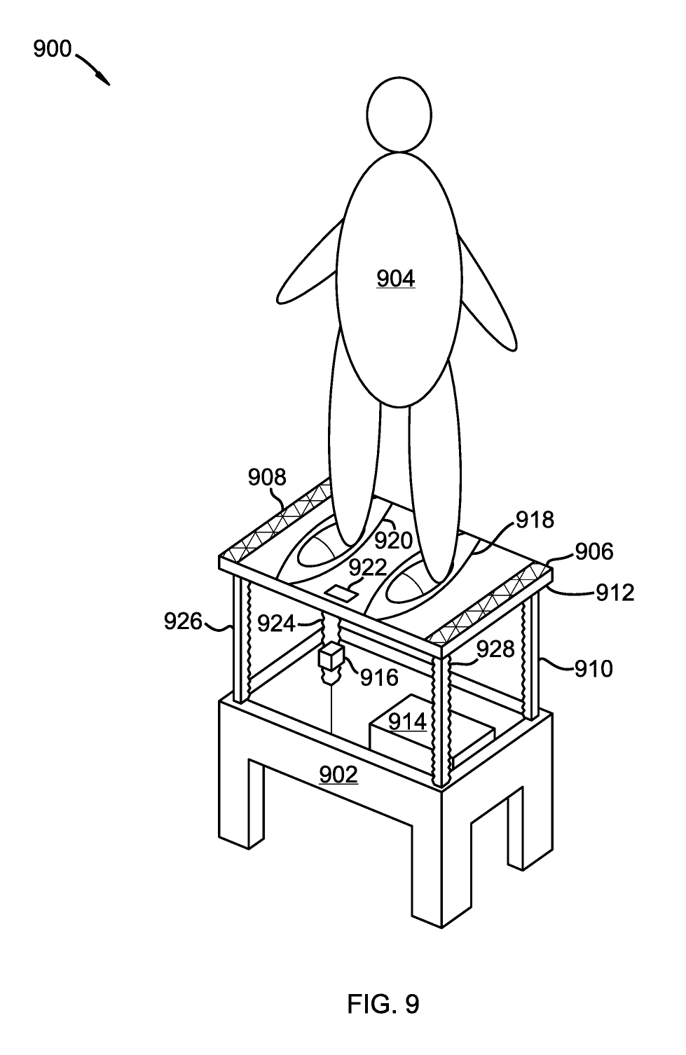

FIG. 9 shows an isometric view of a user-identifying adjustable footstool 902 in use by a user 904. The top surface 912 is in a raised position, supported by lifting mechanisms 910, 924, 926, and 928. The lifting mechanisms 910, 924, 926, and 928 may be moved by an electric, pneumatic, or hydraulic motor 916. Motor 916 may also be a plurality of motors that work in unison. Electronic components 914 may be housed within the body of the user-identifying adjustable footstool 902. The user 904 is shown utilizing the footpads 918 and 920 such that sensors within the footpads 918 and 920 may successfully identify the user 904 and adjust according to the user's 904 preference. Two speakers 908 and 906 are a part of the top surface 912 and a screen 922 is also a part of the top surface 912 for display of information sent from the electronic components 914 that may include weight, body temperature, or other data collected by sensors in the footpads 918 and 920. Here the user is using the footstool 902 to elevate the user so the user can perform a function or task while elevated, similar to a ladder.

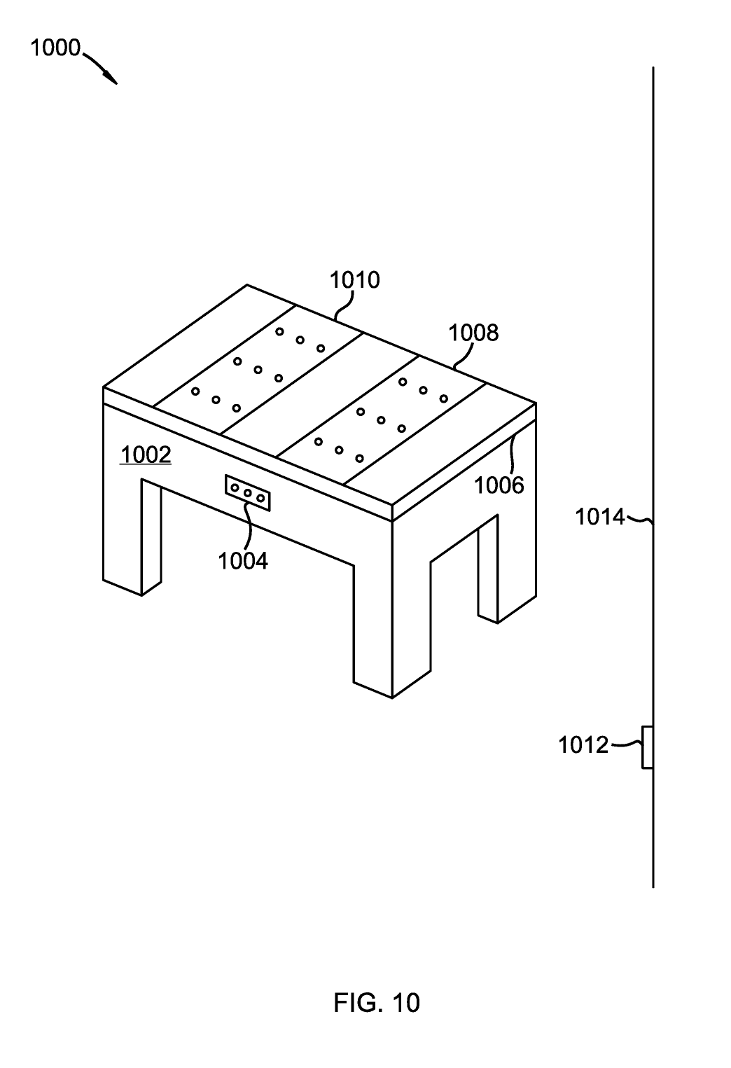

FIG. 10 shows a user-identifying adjustable footstool 1002 that comprises a top surface 1006, the top surface 1006 further comprising footpads with sensors 1010 and 1008. The body of the user-identifying adjustable footstool comprises an attachment mechanism 1004 that may attach to a compatible attachment mechanism 1012 that is fixed to a surface 1014 to allow for immobilization of the user-identifying adjustable footstool 1002. The attachment mechanisms 1004 and 1012 may also be used to charge the user-identifying footstool 1002 from a power source that may be attached to the attachment mechanism 1012.

The systems and methods disclosed herein may be embodied in other specific forms without departing from their spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user-identifying adjustable footstool comprising:
a platform comprising two foot pads, a processor, and a memory, the two foot pads further comprising a plurality of sensors;
a mechanism for adjusting the platform;
the memory comprising user identification data and user preferences based on input from the plurality of sensors; wherein
the platform self-adjusts according to the user preferences.

2. The user-identifying adjustable footstool of claim 1, wherein the footstool attaches or connects to a toilet.

3. The toilet footstool of claim 2, wherein the toilet footstool has a concave side for nesting with a base of the toilet and may be used to achieve a squatting position during defecation.

4. The user-identifying adjustable footstool of claim 1, wherein a side has an attachment mechanism in order to be immobilized by secure attachment to a surface with a compatible attachment mechanism.

5. The user-identifying adjustable footstool of claim 2, wherein the platform may rotate in order to create a more ergonomic angle between feet of a user and the user-identifying adjustable footstool.

6. The user-identifying adjustable footstool of claim 4, wherein the two foot pads have a contoured surface for increased comfort.

7. The user-identifying adjustable footstool of claim 1, wherein the platform comprises a thermal pad and controller.

8. The user-identifying adjustable footstool of claim 7, wherein a user's preferred temperature is stored in the memory and connected to a user profile such that the thermal pad will be self-adjusted by the processor upon identification of a user by the user-identifying adjustable footstool.

9. The user-identifying footstool of claim 2, wherein a surface of the user-identifying adjustable footstool comprises a screen that relays data collected by the processor.

10. The user-identifying adjustable footstool of claim 1, wherein the platform comprises ridges for increased traction.

11. The user-identifying adjustable footstool of claim 1, wherein the platform comprises a massage pad and a controller.

12. The user-identifying adjustable footstool of claim 11, wherein a user's preferred massage duration, pattern, and intensity is stored in the memory and connected to a user profile such that the massage pad will self-initiate a preferred massage routine after identification of a user by the user-identifying adjustable footstool.

13. The user-identifying adjustable footstool of claim 1, wherein the platform comprises a scale.

14. The user-identifying adjustable footstool of claim 1, further comprising speakers and a retractable audio cable with a 3.5 mm jack and wherein the processor has wireless connection capabilities that allow for wireless control of the speakers.

15. The user-identifying adjustable footstool of claim 1, wherein the platform comprises a plurality of motion or pressure activated lights for illumination in a dark environment.

16. The user-identifying adjustable footstool of claim 1, wherein the support material rests on a plurality of locking rollers for increased mobility.

17. The user-identifying adjustable footstool of claim 7, wherein the controller comprises a fingerprint sensor.

18. The user-identifying adjustable footstool of claim 1, wherein the platform is adjusted by means of four electronically powered rack and pinion supports.

19. The user-identifying adjustable footstool of claim 1, wherein the platform is adjusted by means of a motorized jack.

20. The user-identifying adjustable footstool of claim 1, wherein the platform is adjusted by means of a hydraulic lift.
